(19) United States
(12) Patent Application Publication
(10) Pub. No.: US 2026/0149974 A1
(43) Pub. Date: May 28, 2026

(54) SYSTEM AND METHODS FOR WIRELESS NETWORK RADIO AND ANTENNA DESIGNS BASED ON INFRASTRUCTURE UPGRADE AND MODIFICATION ANAYSIS

(71) Applicant: Congruex Group LLC, Boulder, CO (US)

(72) Inventors: Herkole Sava, Centreville, VA (US); Michael Seymour, Dallas, TX (US); Khaibar Noorzad, Kennedale, TX (US); Kyle Wyant, North Richland Hills, TX (US)

(21) Appl. No.: 18/961,948

(22) Filed: Nov. 27, 2024

(51) Int. Cl. H04W 16/18; G06Q 10/063

(52) U.S. Cl. CPC H04W 16/18; G06Q 10/063

(57) ABSTRACT

A computer system is provided. The computer system programmed to: 1) receive parameters for a first design; 2) for each tower of the plurality of towers, the computer system programmed to: a) select a tower of the plurality of towers; b) calculate an initial site structure analysis cost for the selected tower; c) for each electronic device of a plurality of electronic devices associated with the selected tower, the computer system programmed to: i) select an electronic device associated with the selected tower; ii) calculate an EPA; iii) determine a mount analysis cost; iv) compare the selected electronic device with the first design; v) determine a tower analysis cost based upon the comparison; and vi) determine an electronic device project cost for the selected radio; and d) determine a tower project cost for the selected tower; and 3) determine a total project cost for the first design.

### BACKGROUND

The field of the disclosure relates generally to infrastructure upgrade and modification analysis, and more particularly, to systems and methods for wireless network radio and antenna designs based on infrastructure structural upgrade and modification analysis.

Currently, wireless network radio industrial form factor design only considers electronic, wireless technology performance specifications as defined by 3GPP (3rd Generation Partnership Project) or wireless operators, energy and heat dissipation, electronic RF (radio frequency) front-end component placement requirements, etc. However, such technological considerations can be met by various dimensions or other parameters of the radio/antennas, such as weight. Furthermore, such analysis requires consideration of many factors that may change based upon the location, climate, outside influences, and other factors. Many of these factors may have a significant impact on deployment of those radios/antennas both from an operational perspective and cost of tower/mount modifications requirements where those radios/antennas are installed at.

Accordingly, a system that takes a comprehensive approach on intelligently designing radio/antenna and real-time adaptation of optimal wireless infrastructure mass scale upgrades/modifications would be desirable.

### BRIEF DESCRIPTION

In one aspect, a computer device for infrastructure upgrade and modification analysis based on wireless network radio and antenna design is provided. The computer system including at least one processor in communication with at least one memory device. The at least one processor is programmed to: A) store a plurality of tower information for a plurality of towers; B) receive parameters for a first design, wherein the first design is for an electronic device; C) for each tower of the plurality of towers, the at least one processor is programmed to: i) select a tower of the plurality of towers; ii) calculate an initial site structure analysis cost for the selected tower; iii) for each electronic device of a plurality of electronic devices associated with the selected tower, the at least one processor is programmed to: a) select an electronic device associated with the selected tower; b) calculate an estimated protective area (EPA) for the first design and the selected electronic device; c) determine a mount analysis cost based upon the calculated EPAs; d) compare the selected electronic device with the first design; e) determine a tower analysis cost based upon the comparison; and f) determine an electronic device project cost for the selected electronic device; and iv) determine a tower project cost for the selected tower and the plurality of electronic devices associated with the selected tower; and D) determine a total project cost for the first design. The computer device may direct additional, less, or alternate functionality, including that discussed elsewhere herein.

In another embodiment, a computer-implemented method for infrastructure upgrade and modification analysis based on wireless network radio and antenna design is provided. The method implemented by a computer system including at least one processor in communication with at least one memory device. The method includes A) storing a plurality of tower information for a plurality of towers and mounts; B) receiving parameters for a first design, wherein the first design is for an electronic device; c) for each tower of the plurality of towers, the method comprises: i) selecting a tower of the plurality of towers and mounts; ii) calculating an initial site structure analysis cost for the selected tower; iii) for each electronic device of a plurality of electronic devices associated with the selected tower, the method comprises: a) selecting an electronic device associated with the selected tower; b) calculating an estimated protective area (EPA) for the first design and the selected electronic device; c) determining a mount analysis cost based upon the calculated EPAs; d) comparing the selected electronic device with the first design; e) determining a tower analysis cost based upon the comparison; and f) determining an electronic device project cost for the selected electronic device; and iv) determining a tower project cost for the selected tower and the plurality of electronic devices associated with the selected tower; and D) determining a total project cost for the first design. The method may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates an exemplary tower site for upgrade/modification in accordance with at least one embodiment of this disclosure.

FIG. 2 illustrates a process for infrastructure upgrade and modification analysis based on wireless network radio and antenna designs in accordance with at least one embodiment of this disclosure.

FIG. 3 illustrates a simplified block diagram of an exemplary computer system for the process shown in FIG. 2.

FIG. 4 illustrates an exemplary configuration of a client computer device shown in FIG. 3, in accordance with one embodiment of the present disclosure.

FIG. 5 depicts an exemplary configuration of a server computer device, in accordance with one embodiment of the present disclosure.

The Figures depict preferred embodiments for purposes of illustration only. One skilled in the art will readily recognize from the following discussion that alternative embodiments of the systems and methods illustrated herein may be employed without departing from the principles of the disclosure described herein.

### DETAILED DESCRIPTION

The present embodiments may relate to, inter alia, wireless network radio and antenna designs based on infrastructure upgrade and modification analysis. The systems and methods presented in this disclosure describe a comprehensive approach in defining the dimension, weight, and other industrial form factor parameters of wireless network radios/antennas prior to finalizing their design and manufacturing in large quantities for a particular mobile network operator or a multitude of operators in a global space. The disclosed approach analyses a range of radio/antenna form factor metrics using a first order tower/mount analysis methodology which would lead to a wireless network radio/antenna upgrade/change cost estimate for mobile network operators. The system considers the implication of radio/antenna forma factors to the wireless network structural upgrades/changes. This is a critically important factor, as mobile operators spend billions of dollars in a yearly basis on those activities. The outcome of this approach is an optimal subset of radio/antenna form factor parameters to the original equipment manufacturers (OEMs) of radio and/or antennas that should be enforced to their final design decisions. Accordingly, the disclosed systems and methods in this writing could lead to substantial savings to mobile network operators.

In the exemplary embodiment, the system is instructed to take a geographic area analyze each tower and each mount on those towers to determine what actions are needed and then estimate the cost of performing the changes in the defined geographic area. In some embodiments, the system also determines which designs are optimal for different regions based on the associate costs and/or needs of the area.

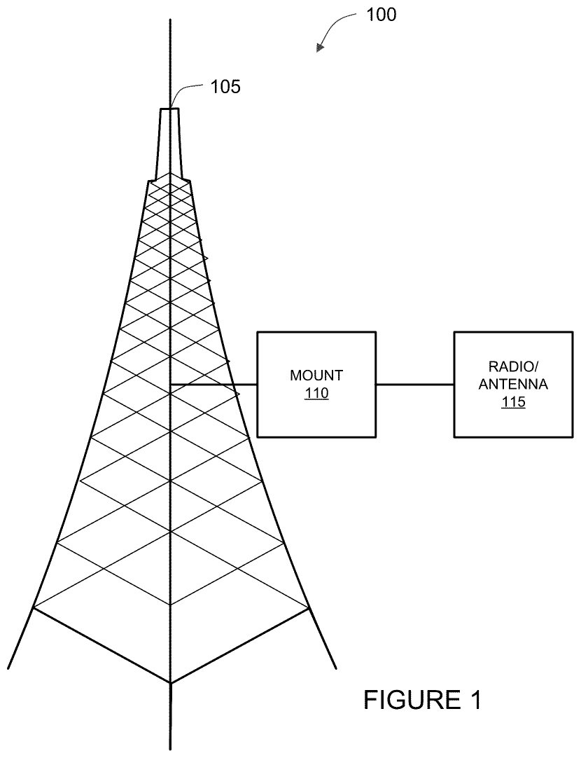

FIG. 1 illustrates an exemplary tower site 100 for upgrade/modification in accordance with at least one embodiment of this disclosure. The tower site 100, includes at least one tower 105. Each tower 105 includes one or more mounts 110, where each mount 110 secures an antenna/radio 115 to the tower 105.

In some embodiments, the tower site 100 is also known as a cell site, a cell phone tower, a cell base tower, and/or cellular base station. The tower 105 may be a radio mast or other raised structure. The tower 105 supports antennas 115, one or more sets of transmitter/receiver transceivers, digital signal processors control electronics, power sources, etc. Mounts 110 include any mounting device or bracket that is used to attach an antenna 115 or antenna array 115 to a monopole, lattice tower, building, or other structure. Antennas/radios 115 any wireless communication device used to support wireless communication, such as, but not limited to a cellular network.

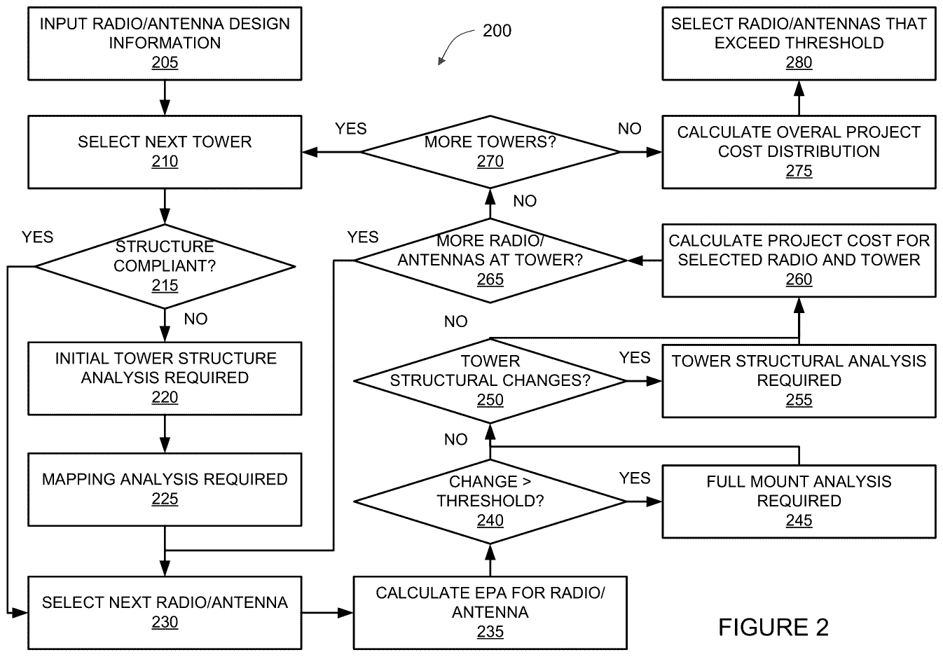

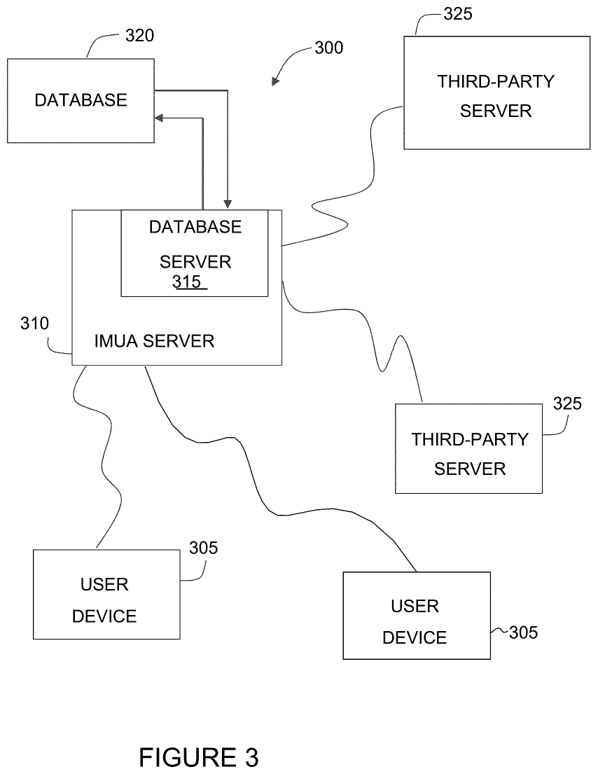

FIG. 2 illustrates a process 200 for infrastructure upgrade and modification analysis based on wireless network radio and antenna designs in accordance with at least one embodiment of this disclosure. In the exemplary embodiment, the steps of process 200 are performed by a computer device, such as the infrastructure modification and upgrade analysis (IMUA) computer device 310 (shown in FIG. 3).

In the example embodiment, the process 200 for infrastructure upgrade and modification analysis based on wireless network radio and antenna designs is performed for a large number of towers 105 (shown in FIG. 1). The process 200 is used by designers of new radios, antennas, and/or mounts. In other embodiments, the process 200 may be performed by individuals associated with the 3GPP, who may be designing a future update to one or more wireless standards. One of the purposes of the process 200 is to analyze different designs for all of the towers 105, mounts 110, and radio/antennas 115 in tower sites 100 (all shown in FIG. 1) in a geographic region and determine a cost (and other issues) associated with each design. For example, in the United States there are upwards of 250 thousand towers sites 100. The process 200 is performed for each of those tower sites 100. In another example, there are currently approximately 1.1 million tower sites 100 in the country of China. Furthermore, other regions, such as Europe or the Scandinavian countries, have large numbers of tower sites 100 as well. This process 200 helps to streamline the analysis of all of the towers 105 and tower sites 100 in a region.

In the example embodiment, the IMUA computer device 310 receives 205 radio/antenna 115 design information. The design defines the parameters of the new radios/antennas 115 such as dimensions (e.g., length, width, depth, weight, etc.) to define the scope of changes required for the new design. In some embodiments, the dimensions are provided in a range to allow for different electronics, energy consumption, cooling, and other factors. In some embodiments, process 200 is executed for different combinations of values for the parameters/dimensions to determine the optimal configuration. In other embodiments, process 200 receives multiple potential configurations from the user to analyze and compare.

In the example embodiment, the radio/antenna OEM provides a series of equipment parameters'ranges that their design based on other parameters can be configured. After receiving 205 those parameters the IMUA computer device 310 calculates a series of actions for all the towers 105/mounts 110 under consideration and the permutations of radio/antenna 115 attribute ranges.

In some embodiments, the user selects a geographic region to analyze. This region may include, but is not limited to, a country, a continent, a state or province, a collection of states or provinces, a geofenced area, or any other geographic area that the user desires. In some embodiments, the user is a mobile network operator. In other embodiments, the user is the radio/antenna OEM.

In the example embodiment, the IMUA computer device 310 has access to information for a large number of tower sites 100 and their corresponding components 105, 110, and 115. For example, in the United States there are upwards of 250 thousand towers sites 100. In some embodiments, the information about the tower sites 100 is stored in one or more databases 320 (shown in FIG. 3). In some further embodiments, some of the information is provided by one or more third-party servers 325 (shown in FIG. 3). In some of these embodiments, the third-party servers 325 may be associated with one or more wireless service providers or one or more companies responsible for maintaining the tower sites 100.

In the example embodiment, the IMUA computer device 310 selects 210 a tower 105 from the list of towers 105. Over the course of the process 200, each tower 105 will be selected 210 and analyzed with its own loops.

In the example embodiment, the IMUA computer device 310 analyzes 215 the selected tower 105 to determine if the selected tower's structural analysis is compliant with national and regulatory codes. The IMUA computer device 310 also determines if the mounts 110 residing on the selected tower 105 are also compliant with national and regulatory codes. If either or both are not compliant, then the IMUA computer device 310 determines 220 that an initial structural analysis (I-STA) is required. The IMUA computer device 310 also determines 225 that a mapping analysis (MA) is also required. The IMUA computer device 310 determines the cost for each an associates that cost with the selected tower 105. Then the IMUA computer device 310 proceeds to step 230.

In the example embodiment, the IMUA computer device 310 selects 230 a radio/antenna 115 for the selected tower 105. Process 200 will loop so that all radio/antennas 115 on each tower 105 will be selected 223 and analyzed with its own loop.

In the example embodiment, the IMUA computer device 310 calculates 235 an effective protective area (EPA) for the selected radio/antenna 115. This calculation defines if a tower 105/mount 110 change condition is triggered, which suggests that further and more detailed analysis is required. Current tower 105 and mount 110 structural data are pulled out of a predefined database 320 that has all the required parameters for the respective mount 115.

Upon EPA calculation 235, the IMUA computer device 310 determines 240 if a mount change condition analysis is required. In one embodiment, the determination 240 is made if there is a 5% increase on calculation EPA between current radio and the new radio that will replace it. In the case of a new radio addition (i.e., no radio replacement) the addition of the radio component on overall EPA needs to be considered. If a mount change condition analysis is required, then the IMUA computer device 310 determines 245 that a full mount analysis (FMA) is requires and adds that cost to the selected tower 105/selected radio/antenna 115. The IMUA computer device 310 also adds the cost of a post mount inspection (PMI).

### Then the Imua Computer Device 310 Determines 250 If a New

tower structural analysis is required. This analysis could be triggered due to radio/antenna 115 changes. The analysis could also be triggered when radio/antenna cables are changed. The cable tower information is collected as part of step 215, or available from prior structure analysis. The new radio/antenna cable requirements are part of the new specification requirements for such equipment. If the tower structural analysis is required, the IMUA computer device 310 determines 255 the cost for the tower structural analysis and adds it to the cost for the selected tower 105.

Next the IMUA computer device 310 calculates 260 the project cost for the selected radio/antenna 115 and tower 105. All the inputs about the required projects and their average costs are then entered into step 260 to calculate the overall project cost for each radio/antenna 115. In some embodiments, the various project costs are stored as part of the historical data analysis of similar projects. Those project costs are counting for the following subprojects: I-STA->Initial Structural Tower Analysis; STA->Structural Analysis Required for each radio/antenna 115 configuration; MA->Mount Analysis required for 115 radio/antenna configuration; MMA->Mount Mapping Analysis required for the mount 115 on the selected tower 105; and/or PMI->Post Modification Inspection required if a Mount Analysis is required.

The IMUA computer device 310 determines 265 if there are more radios/antennas 115 and their parameters to analyze on the selected tower 105. If there are more radios/antennas 115 to be analyzed, the IMUA computer device 310 continues to step 230. The IMUA computer device 310 performs this loop for each radio/antenna 115 on each tower 105.

If there are no more radios/antennas 115 on the selected tower 105 to analyze, the IMUA computer device 310 determines 270 if there are more towers 105 to analyze. If there are more towers 105 to be analyzed, the IMUA computer device 310 continues to step 210. The IMUA computer device 310 performs these loops for each tower 105.

Once all of the towers 105 have been analyzed, the IMUA computer device 310 calculates 275 the overall project cost distribution for all of the towers 105 and all of the radio/antennas 115. This analysis is performed for different ranges of parameters for the new design of the radio/antennas 115. When the entire analysis is completed a full range of costs is presented to user. In the example embodiment, the IMUA computer device 310 selects 280 the radio/antenna designs that exceed one or more thresholds. For example, the thresholds may include being the top 10% most cost effective designs. These thresholds are user configurable. For example, one user may want to see designs that trigger the least number of tower structural analyses or any other factor.

FIG. 3 illustrates an exemplary computer system 300 for performing the process 200 (shown in FIG. 2). In the exemplary embodiment, the system 300 is used for infrastructure upgrade and modification analysis based on wireless network radio and antenna designs.

As described below in more detail, the infrastructure modification and upgrade analysis (IMUA) computer device 310 may be programmed for infrastructure upgrade and modification analysis based on wireless network radio and antenna designs. In some embodiments, the IMUA computer device 310 may be programmed to A) store a plurality of tower information for the plurality of towers 105; B) receive parameters for a first design, wherein the first design is for an electronic device 115; C) for each tower 105 of the plurality of towers 105, the at least one processor is programmed to: i) select a tower 105 of the plurality of towers 105; ii) calculate an initial site structure analysis cost for the selected tower 105; iii) for each electronic device of a plurality of electronic devices 115 associated with the selected tower 105, the at least one processor is programmed to: a) select an electronic device 115 associated with the selected tower 105; b) calculate an estimated protective area (EPA) for the first design and the selected electronic device 115; c) determine a mount analysis cost based upon the calculated EPAs; d) compare the selected electronic device 115 with the first design; e) determine a tower analysis cost based upon the comparison; and f) determine an electronic device project cost for the selected electronic device 115; and iv) determine a tower project cost for the selected tower 105 and the plurality of electronic devices 115 associated with the selected tower 105; and D) determine a total project cost for the first design.

In the example embodiment, user devices 305 are computers that include a web browser or a software application, which enables user devices 305 to communicate with IMUA computer device 310 using the Internet, a local area network (LAN), or a wide area network (WAN). In some embodiments, the user devices 305 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. User devices 305 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the example embodiment, the infrastructure modification and upgrade analysis (IMUA) computer device 310 (also known as IMUA server 310) is a computer that include a web browser or a software application, which enables IMUA computer device 310 to communicate with user devices 305 using the Internet, a local area network (LAN), or a wide area network (WAN). In some embodiments, the IMUA computer device 310 is communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. IMUA computer device 310 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

A database server 315 is communicatively coupled to a database 320 that stores data. In one embodiment, the database 320 is a database that includes network equipment information and/or historical mount analysis data. In some embodiments, the database 320 is stored remotely from the IMUA computer device 310. In some embodiments, the database 320 is decentralized. In the example embodiment, a person can access the database 320 via the user devices 305 by logging onto IMUA computer device 310.

Third-party servers 325 may be any third-party server to provide information that IMUA computer device 310 is in communication with that provides additional functionality and/or information to IMUA computer device 310. For example, third-party server 325 may provide reports on towers 105 (shown in FIG. 1) and/or equipment on those towers 105 for different geographic regions. In the example embodiment, third-party servers 325 are computers that include a web browser or a software application, which enables third-party servers 325 to communicate with IMUA computer device 310 using the Internet, a local area network (LAN), or a wide area network (WAN).

In some embodiments, the third-party servers 325 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Third-party servers 325 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

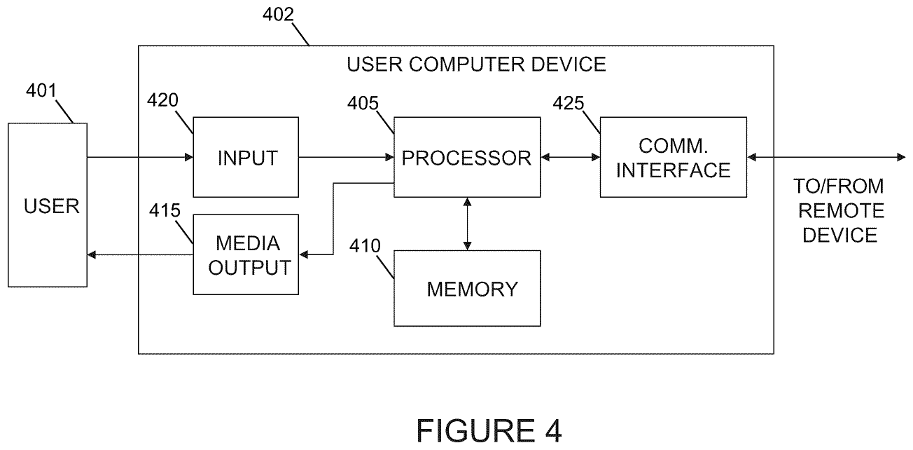

FIG. 4 depicts an exemplary configuration 400 of user computer device 402, in accordance with one embodiment of the present disclosure. In the exemplary embodiment, user computer device 402 may be similar to, or the same as, user device 305 (shown in FIG. 3). User computer device 402 may be operated by a user 401.

User computer device 402 may include a processor 405 for executing instructions. In some embodiments, executable instructions may be stored in a memory area 410. Processor 405 may include one or more processing units (e.g., in a multi-core configuration). Memory area 410 may be any device allowing information such as executable instructions and/or transaction data to be stored and retrieved. Memory area 410 may include one or more computer readable media.

User computer device 402 may also include at least one media output component 415 for presenting information to user 401. Media output component 415 may be any component capable of conveying information to user 401. In some embodiments, media output component 415 may include an output adapter (not shown) such as a video adapter and/or an audio adapter. An output adapter may be operatively coupled to processor 405 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 415 may be configured to present a graphical user interface (e.g., a web browser and/or a client application) to user 401. A graphical user interface may include, for example, an interface for viewing items of information provided by the IMUA computer device 310 (shown in FIG. 3). In some embodiments, user computer device 402 may include an input device 420 for receiving input from user 401. User 401 may use input device 420 to, without limitation, provide information either through speech or typing.

Input device 420 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 415 and input device 420.

User computer device 402 may also include a communication interface 425, communicatively coupled to a remote device such as IMUA computer device 310. Communication interface 425 may include, for example, a wired or wireless network adapter and/or a wireless data transceiver for use with a mobile telecommunications network.

Stored in memory area 410 are, for example, computer readable instructions for providing a user interface to user 401 via media output component 415 and, optionally, receiving and processing input from input device 420. A user interface may include, among other possibilities, a web browser and/or a client application. Web browsers enable users, such as user 401, to display and interact with media and other information typically embedded on a web page or a website from IMUA computer device 310. A client application may allow user 401 to interact with, for example, IMUA computer device 310. For example, instructions may be stored by a cloud service, and the output of the execution of the instructions sent to the media output component 415.

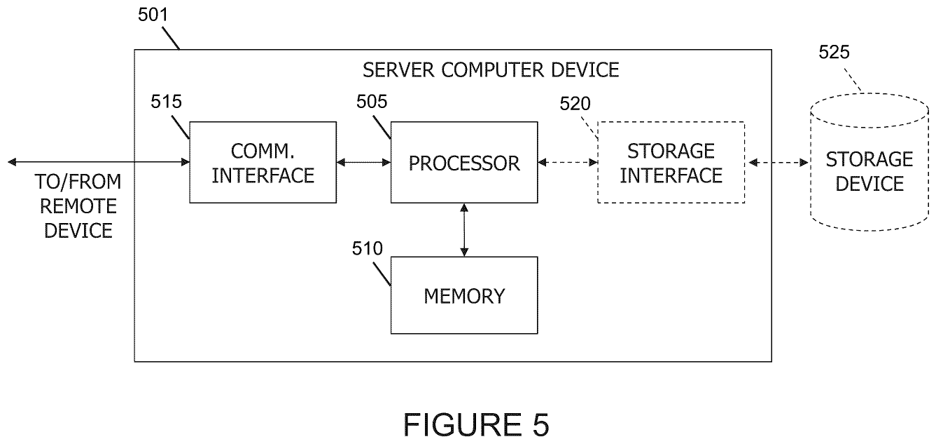

FIG. 5 depicts an exemplary configuration 500 of a server computer device 501, in accordance with one embodiment of the present disclosure. In the exemplary embodiment, server computer device 501 may be similar to, or the same as, IMUA computer device 310, database server 315, and third-party server 325 (all shown in FIG. 3). Server computer device 501 may also include a processor 505 for executing instructions. Instructions may be stored in a memory area 510. Processor 505 may include one or more processing units (e.g., in a multi-core configuration).

Processor 505 may be operatively coupled to a communication interface 515 such that server computer device 501 is capable of communicating with a remote device such as another server computer device 501, IMUA computer device 310, third-party servers 325, and user devices 305 (shown in FIG. 3) (for example, using wireless communication or data transmission over one or more radio links or digital communication channels). For example, communication interface 515 may receive input from user devices 305 via the Internet, as illustrated in FIG. 3.

Processor 505 may also be operatively coupled to a storage device 525. Storage device 525 may be any computer-operated hardware suitable for storing and/or retrieving data, such as, but not limited to, data associated with one or more models. In some embodiments, storage device 525 may be integrated in server computer device 501. For example, server computer device 501 may include one or more hard disk drives as storage device 525.

In other embodiments, storage device 525 may be external to server computer device 501 and may be accessed by a plurality of server computer devices 501. For example, storage device 525 may include a storage area network (SAN), a network attached storage (NAS) system, and/or multiple storage units such as hard disks and/or solid-state disks in a redundant array of inexpensive disks (RAID) configuration.

In some embodiments, processor 505 may be operatively coupled to storage device 525 via a storage interface 520. Storage interface 520 may be any component capable of providing processor 505 with access to storage device 525. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 505 with access to storage device 525.

Processor 505 may execute computer-executable instructions for implementing aspects of the disclosure. In some embodiments, the processor 505 may be transformed into a special purpose microprocessor by executing computer-executable instructions or by otherwise being programmed. For example, the processor 505 may be programmed with the instruction such as illustrated in FIG. 2.

In the example embodiment, the IMUA computer system 310 is configured for infrastructure upgrade and modification analysis based on wireless network radio and antenna designs. The IMUA computer system 310 includes at least one processor 505 in communication with at least one memory device 510.

In the example embodiment, the IMUA computer system 310 stores a plurality of tower information for a plurality of towers 15, such as in one or more databases 320. In the example embodiment, the IMUA computer system 310 receives 205 parameters for a first design, wherein the first design is for an electronic device 115, such as a radio or antenna.

In the example embodiment, for each tower 105 of the plurality of towers 105, the IMUA computer system 310 selects 210 a tower 105 of the plurality of towers 105. The IMUA computer system 310 calculates an initial site structure analysis cost for the selected tower 105. The initial site structure analysis cost is determined if the selected tower 105 is compliant with regulatory codes. If the selected tower 105 is compliant, then initial site structure analysis cost is zero. If the selected tower 105 is not compliant, the IMUA computer system 310 adds 220 in a cost of an initial tower structural analysis. If the selected tower 105 is not compliant, the IMUA computer system 310 also adds 225 in a cost of a mapping analysis.

For each electronic device 115 of a plurality of electronic devices 115 associated with the selected tower 105, the IMUA computer system 310 select 230 an electronic device 115 associated with the selected tower 105. The IMUA computer system 310 calculates 130 an estimated protective area (EPA) for the first design and the selected electronic device 115. The IMUA computer system 310 determines 245 a mount analysis cost based upon the calculated EPAs. The IMUA computer system 310 compares the selected electronic device 115 with the first design. The IMUA computer system 310 determines 255 a tower analysis cost based upon the comparison. The IMUA computer system 310 determines 260 an electronic device project cost for the selected electronic device 115.

For each tower 105 of the plurality of towers 105, the IMUA computer system 310 determines a tower project cost for the selected tower 105 and the plurality of electronic devices 115 associated with the selected tower 105.

The IMUA computer system 310 determines 275 a total project cost for the first design.

The IMUA computer system 310 selects a geographic region. The IMUA computer system 310 determines the plurality of towers 105 in the geographic region. The IMUA computer system 310 stores the results of the initial tower structural analysis for subsequent tower analysis.

The IMUA computer system 310 receives 205 parameters for a first design. The first design includes a plurality of dimensions. The plurality of dimensions includes a plurality of ranges for one or more dimensions. The IMUA computer system 310 selects a first set of dimensions within the plurality of ranges. The IMUA computer system 310 executes analysis for the first design for the first set of dimensions. The IMUA computer system 310 generates a plurality of sets of dimensions within the plurality of ranges. The IMUA computer system 310 executes analysis of the plurality of towers 105 for each set of dimensions for the plurality of ranges. The IMUA computer system 310 compares results of each analysis of the plurality of towers 105 for each set of dimensions for the plurality of ranges. The IMUA computer system 310 selects one or more sets of dimensions for the first design based upon the comparison. The IMUA computer system 310 selects 280 the one or more sets of dimensions based upon a comparison of the total project cost for the corresponding plurality of sets of dimensions.

In some embodiments, the number of towers 105 in the plurality of towers exceeds 100,000 towers 105. In other embodiments, wherein the number of towers 105 in the plurality of towers exceeds 250,000 towers 105.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, IMUA computer device 310 is configured to implement machine learning, such that IMUA computer device 310 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images, text data, and/or other types of data (i.e., multi-modal type of data). ML outputs may include, but are not limited to identified objects, items classifications, textual product, and/or other data extracted from the images or textual data. In some embodiments, data inputs may include certain ML outputs (i.e., overall convergence optimization parameters or multiple localized convergence points that lack an optimal convergence point).

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of text with known characteristics or features. Such information may include, for example, information associated with a plurality of text of a plurality of different towers, mounts, and/or radios.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify tower clusters and patterns that may then be applied to determining assignments. The processing element may also learn how to identify attributes of different towers and assignments. This information may be used to determine which towers to cluster together.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS′ include, but are not limited to including, Oracle® Database, MySQL, IBM® DB2, Microsoft® SQL Server, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; and Microsoft is a registered trademark of Microsoft Corporation, Redmond, Washington.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer system for infrastructure upgrade and modification analysis based on wireless network radio and antenna designs, the computer system including at least one processor in communication with at least one memory device, the at least one processor programmed to:
store a plurality of tower information for a plurality of towers;
receive parameters for a first design, wherein the first design is for an electronic device;
for each tower of the plurality of towers, the at least one processor is programmed to:
select a tower of the plurality of towers;
calculate an initial site structure analysis cost for the selected tower;
for each electronic device of a plurality of electronic devices associated with the selected tower, the at least one processor is programmed to:
select an electronic device associated with the selected tower;
calculate an estimated protective area (EPA) for the first design and the selected electronic device;
determine a mount analysis cost based upon the calculated EPAs;
compare the selected electronic device with the first design;
determine a tower analysis cost based upon the comparison; and
determine an electronic device project cost for the selected electronic device; and
determine a tower project cost for the selected tower and the plurality of electronic devices associated with the selected tower; and
determine a total project cost for the first design.

2. The computer system of claim 1, wherein the electronic device is at least one of a radio and an antenna.

3. The computer system of claim 1, wherein the at least one processor is further programmed to:
select a geographic region; and
determine the plurality of towers in the geographic region.

4. The computer system of claim 1, wherein the at least one processor is further programmed to:
determine if the selected tower is compliant with regulatory codes; and
add in a cost of an initial tower structural analysis if the selected tower is not compliant.

5. The computer system of claim 4, wherein the at least one processor is further programmed to add in a cost of a mapping analysis if the selected tower is not compliant.

6. The computer system of claim 4, wherein the at least one processor is further programmed to store the results of the initial tower structural analysis for subsequent tower analysis.

7. The computer system of claim 1, wherein the at least one processor is further programmed to receive parameters for a first design, wherein the first design includes a plurality of dimensions, and wherein the plurality of dimensions includes a plurality of ranges for one or more dimensions.

8. The computer system of claim 7, wherein the at least one processor is further programmed to:
select a first set of dimensions within the plurality of ranges; and
execute analysis for the first design for the first set of dimensions.

9. The computer system of claim 7, wherein the at least one processor is further programmed to:
generate a plurality of sets of dimensions within the plurality of ranges; and
execute analysis of the plurality of towers for each set of dimensions for the plurality of ranges.

10. The computer system of claim 9, wherein the at least one processor is further programmed to:
compare results of each analysis of the plurality of towers for each set of dimensions for the plurality of ranges; and
select one or more sets of dimensions for the first design based upon the comparison.

11. The computer system of claim 10, wherein the at least one processor is further programmed to select the one or more sets of dimensions based upon a comparison of the total project cost for the corresponding plurality of sets of dimensions.

12. The computer system of claim 1, wherein a number of towers in the plurality of towers exceeds 100,000 towers.

13. The computer system of claim 1, wherein the number of towers in the plurality of towers exceeds 250,000 towers.

14. A computer-implemented method for wireless structure update systems implemented by a computer system including at least one processor in communication with at least one memory device, the method comprising:
storing a plurality of tower information for a plurality of towers;
receiving parameters for a first design, wherein the first design is for an electronic device;
for each tower of the plurality of towers, the method comprises:
selecting a tower of the plurality of towers;
calculating an initial site structure analysis cost for the selected tower;
for each electronic device of a plurality of electronic devices associated with the selected tower, the method comprises:
selecting an electronic device associated with the selected tower;
calculating an estimated protective area (EPA) for the first design and the selected electronic device;
determining a mount analysis cost based upon the calculated EPAs;
comparing the selected electronic device with the first design;
determining a tower analysis cost based upon the comparison; and
determining an electronic device project cost for the selected electronic device; and
determining a tower project cost for the selected tower and the plurality of electronic devices associated with the selected tower; and
determining a total project cost for the first design.

15. The method of claim 14, wherein the electronic device is at least one of a radio and an antenna.

16. The method of claim 14 further comprising receiving parameters for a first design, wherein the first design includes a plurality of dimensions, and wherein the plurality of dimensions includes a plurality of ranges for one or more dimensions.

17. The method of claim 16 further comprising:
selecting a first set of dimensions within the plurality of ranges; and
executing analysis for the first design for the first set of dimensions.

18. The method of claim 16 further comprising:
generating a plurality of sets of dimensions within the plurality of ranges;
executing analysis of the plurality of towers for each set of dimensions for the plurality of ranges.
comparing results of each analysis of the plurality of towers for each set of dimensions for the plurality of ranges; and
selecting one or more sets of dimensions for the first design based upon the comparison.

19. The method of claim 18 further comprising selecting the one or more sets of dimensions based upon a comparison of the total project cost for the corresponding plurality of sets of dimensions.

20. The method of claim 14, wherein the number of towers in the plurality of towers exceeds 250,000 towers.
